(19) United States
(12) Patent Application Publication
(10) Pub. No.: US 2025/0343471 A1
(43) Pub. Date: Nov. 6, 2025

(54) SYSTEM TO REPURPOSE MOTOR WINDINGS

(71) Applicant: Tyco Fire & Security GmbH, Neuhausen am Rheinfall (CH)

(72) Inventors: Christopher P. Brophy, Cedarburg, WI (US); Daniel Hjortland, Milwaukee, WI (US); Julianne Frances Haugh, Milwaukee, WI (US); Jason James Raasch, Cedarburg, WI (US)

(73) Assignee: Tyco Fire & Security GmbH, Neuhausen am Rheinfall (CH)

(21) Appl. No.: 19/198,876

(22) Filed: May 5, 2025

Related U.S. Application Data
(60) Provisional application No. 63/643,201, filed on May 6, 2024.

(51) Int. Cl. H02K 11/00; H01F 27/40; H02K 3/28; H02K 11/33; H02K 15/50

(52) U.S. Cl. CPC H02K 11/0094; H01F 27/40; H02K 3/28; H02K 11/33; H02K 15/50; H02K 2213/06

(57) ABSTRACT

A system to repurpose one or more windings of a motor is disclosed. The system comprises an electrical device and a control circuitry provided to selectively establish electrical connection between one or more windings of the motor and the electrical device. The one or more windings function as an inductor for the electrical device.

### CROSS REFERENCE TO RELATED PATENT APPLICATIONS

This application claims the benefit of and the priority to U.S. Provisional Patent Application No. 63/643,201, filed May 6, 2024, the entire disclosure of which is incorporated by reference herein.

### BACKGROUND

The present disclosure relates to the field of motor windings.

A motor includes one or more windings of electrical conductor positioned between a housing and a rotor of the motor. When the motor is commutating, one or more windings provide motion to the rotor. For example, the motor may be coupled to a valve. The windings are energized to provide motion to the rotor to control operation of the valve.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In accordance with one aspect of the present disclosure, a system to repurpose one or more windings of a motor is disclosed. The system comprises an electrical device and a control circuitry provided to selectively establish electrical connection between one or more windings of the motor and the electrical device. The one or more windings function as an inductor for the electrical device.

In some embodiments, the electrical device is a switched-mode power supply unit.

In some embodiments, the one or more windings are center tapped to provide a precise inductance value.

In some embodiments, the control circuitry establishes electrical connection between the windings and the electrical device when the motor is idle.

In some embodiments, the motor is commutating, and the control circuitry establishes electrical connection between one or more idle windings and the electrical device.

In some embodiments, the windings are combined in one of a parallel, series, or series-parallel combinations.

In accordance with another aspect of the present disclosure, a system to repurpose one or more windings of one or more motors is disclosed. The system comprises one or more electrical devices and a control circuitry provided to selectively establish electrical connection between one or more idle windings of the one or more motors and the one or more electrical devices. The idle windings function as an inductor for the electrical devices.

In accordance with another aspect of the present disclosure, a method is disclosed. The method comprises steps of receiving operational status of one or more motors, and selectively connecting one or more idle windings of the one or more motors to one or more electrical devices. The one or more idle windings function as an inductor for the electrical devices.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram depicting a system to repurpose one or more windings of a motor, in accordance with one aspect of the present disclosure.

FIGS. 2a-2c are block diagrams depicting the system, in accordance with another aspect of the present disclosure.

FIG. 3 is a block diagram depicting the system, in accordance with yet another aspect of the present disclosure.

FIG. 4 is a block diagram depicting steps of a method to repurpose one or more windings of one or more motors.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

### System to Repurpose Motor Windings

An electric motor includes one or more windings made up of electrical conductor. The motor has a housing and a rotor positioned in the housing. The motor further includes a stator to house the windings. The stator may be positioned between the housing and the rotor. Preferably, the windings are positioned in slots provided on the stator. When energized, the windings provide motion to the rotor. The electric motor may be a single phase or a multiphase motor, for example, a three phase electric motor. Number of windings in the motor depends on several factors, such as number of poles, total phases of the motor, slots in stator, etc.

The rotor of the electric motor may be coupled to any suitable device to transmit motion. For example, the electric motor may be a part of a valve actuator that controls operation of a valve. The rotor may be coupled to a control member of the valve. The motor is utilized to control operation of the control member. For example, the motor may be operated to move the control member to open a normally closed valve. In other example, the motor may be operated to move the control member to close a normally open valve. The rotor of the motor can be rotated in a clockwise direction or in an anti-clockwise direction via a control circuitry of the motor.

The valve actuator may include an energy storage element (for example, a capacitor, a battery, etc.). When the valve actuator experiences power loss, the energy storage element may supply energy to the motor to bring the rotor of the motor to a predetermined position, like a home position. The energy storage element may form a part of a fail-safe mechanism for the valve actuator, wherein the energy storage element discharges to bring the control member of the valve to a safe position in case of power loss. In some embodiments, the actuator is a failsafe return actuator that returns to a failsafe position in the event of a power loss.

When the motor is idle or one or more windings in the motor are not providing motion to the rotor, inductance in such windings can be utilized in suitable electrical devices so that the windings function as an inductor for that device. The present disclosure discloses a system to repurpose motor windings so that inductance in the motor windings can be utilized.

According to an aspect of the present disclosure, the system includes an electrical device and a control circuitry to selectively establish electrical connection between one or more windings of the motor and the electrical device. The control circuitry connects the one or more windings to the electrical device such that the one or more windings function as an inductor for the electrical device.

In some embodiments, the electrical device may be a switching mode power supply unit, wherein the control circuitry may establish electrical connection between the switching mode power supply and idle windings of a motor such that the idle windings function as an inductor in the switching mode power supply unit. Further, the switching mode power supply can be a buck power supply, a boost power supply, a buck-boost power supply, flyback power supply, fly-buck power supply, etc. When the motor or one or more windings in the motor are idle, the idle windings may be utilized in a buck power supply to charge the energy storage element of the valve actuator when the motor is not driving an actuator.

In some other embodiments, the electrical device may be a Single Inductor Multiple Output (SIMO) power supply regulator implemented to provide multiple voltage outputs from a single motor winding.

In accordance with another aspect of the present disclosure, repurposing of the motor windings may be accomplished for more than one motor. The control circuitry may establish electrical communication of one or more idle windings of motors with the electrical device. In some embodiments, the control circuitry may establish electrical communication of the idle windings with more than one electrical devices. For example, the control circuitry may associate the idle windings with multiple electrical devices such that each electrical device may be in selective communication with certain motor windings.

In accordance with yet another aspect, a method to repurpose one or more windings of one or more motors is described. The method comprises steps of receiving operational status of one or more motors, and selectively connecting one or more idle windings of the one or more motors to an electrical device. The one or more idle windings function as an inductor for the electrical device.

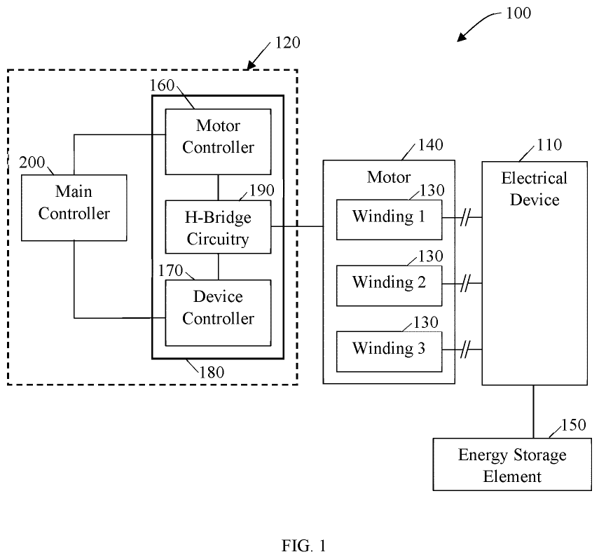

FIG. 1 is a block diagram depicting a system 100, in accordance with one aspect of the present disclosure. Referring to FIG. 1, the system 100 is shown to include an electrical device 110 and a control circuitry 120. The electrical device 110 may be electrically coupled to windings 130 of a motor 140 via an electrical circuit. The windings 130 and components of the electrical device 110 may be a part of the electrical circuit. Further, the electrical circuit may include other suitable components in electrical communication with each other to facilitate the windings 130 to function as an inductor in the electrical device 110.

The electrical device 110 may be any device requiring an inductor for its operation. In some embodiments, the electrical device 110 may be a switching mode power supply (SMPS) unit. The system 100 eliminates need of separate inductor in the SMPS unit, and connects one or more idle windings of a motor with the SMPS unit such that the windings function as an inductor. The SMPS unit may be a buck converter provided to decrease voltage and increase current from a supply to a load. In some examples, the SMPS unit may be a boost converter provided to increase voltage of input signal and generate output signal of higher voltage. In some other examples, the SMPS unit may be a flyback converter.

In some embodiments, the SMPS unit may be implemented to charge an energy storage element 150 based on inductance in the windings 130. More specifically, the electrical device 110, i.e., the SMPS unit can be a buck power supply unit in communication with the energy storage element 150 to charge the energy storage element 150 by utilizing inductance in the windings 130 when the motor 140 is idle. The energy storage element 150 may be a part of a valve actuator powered by the motor 140.

In some other embodiments, the electrical device 110 may be a Single Inductor Multiple Output (SIMO) power supply regulators implemented to provide multiple voltage outputs from a single winding 130.

The control circuitry 120 may include a motor controller 160 configured to control operation of the motor 140. The motor controller 160 may include necessary computing and controlling components. The motor controller 160 may include a processor and a memory. The processor can be a general purpose or specific purpose processor. The processor may be configured to execute computer code or instructions stored in the memory or received from other computer readable media (e.g., CDROM, network storage, a remote server, etc.). The memory may include one or more devices (e.g., memory units, memory devices, storage devices, etc.) for storing data and/or computer code for completing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, or any other type of information structure for supporting the various activities and information structures described in the present disclosure. The memory may be communicably connected to the processor and may include computer code for executing (e.g., by the processor) one or more processes described herein.

The control circuitry 120 further includes a device controller 170 configured to control operation of the electrical device 110. For example, in case of the electrical device 110 being an SMPS unit, the device controller 170 is an SMPS controller configured to control operation of the SMPS unit. The device controller 170 may have necessary computing and controlling components, such as a processor, a memory, etc.

In some embodiments, the motor controller 160 and the device controller 170 are physically separate components, and communicate with each other via wired or wireless communication means. In some other embodiments, as shown in FIG. 1, the motor controller 160 and the device controller 170 may be integrated on an integrated chip 180, for example, an application-specific integrated circuit (ASIC). In such case, the motor controller 160 and the device controller 170 may share certain components, for example, a processor, a memory, etc.

The control circuitry 120 may further include H-bridge circuitry 190 configured to enable bidirectional driving of the motor 140. The H-bridge circuitry 190 may include switches for reversing operation of the motor 140. For example, the H-bridge circuitry 190 may include four switches. Operation of the motor 140 (for example, clockwise or anticlockwise rotation of the rotor of the motor 140) is controlled by selectively opening or closing the switches. In some embodiments, the switches may be metal-oxide-semiconductor field-effect transistor (MOSFET) switches. Although the present disclosure is described with reference to the motor 140 implemented with the H-bridge circuitry 190, the motor 140 can have any other suitable topology for controlling operation of the motor 140.

The control circuitry 120 may further include a main controller 200. The main controller 200 may control operation of the valve actuator having the motor 140. In some embodiments, the main controller 200 may be configured to control an operation of an equipment or a system (for example, an HVAC system) in which the motor 140 is implemented.

The control circuitry 120 is configured to determine operational status of the motor 140, and further establish electrical communication between the one or more windings 130 and the electrical device 110, when the motor 140 is idle.

In some embodiments, the main controller 200 may request operation status of the motor 140 to the motor controller 160. When the motor 140 is idle, i.e., not commutating, the windings 130 do not provide motion to the rotor of the motor 140. As such, the main controller 200 may communicate with the motor controller 160 to connect one or more windings 130 of the motor 140 with the electrical device 110 such that connected windings 130 function as an inductor for the electrical device 110. When the motor 140 is not commutating, the main controller 200 may connect the one or more windings 130 to the electrical device 110 such that connected windings 130 function as an inductor for the electrical device 110. The main controller 200 may continue electrical connection between the one or more windings 130 and the electrical device 110 till the motor 140 is not commutating.

In some other embodiments, the main controller 200 may communicate with the device controller 170 to receive required inductance value. The main controller 200 may further communicate with the motor controller 160 to prevent windings 130 to provide motion to the rotor, and electrically connect one or more windings 130 of the motor 140 with the electrical device 110 such that connected windings 130 function as an inductor for the electrical device 110.

The control circuitry 120 may determine frequency of switching the windings 130 to function as an inductor based on a nominal inductance value, or based on a model number or other identifier related to an equipment in which the motor 140 is implemented.

The windings 130 and the electrical device 110 may be coupled via an electronic circuit having switches. The switches may be part of the H-bridge circuitry 190 or provided separately. The motor controller 160 or the device controller 170 may control the switches to establish electrical connection between the windings 130 and the electrical device 110. For example, the motor controller 160 or the device controller 170 may control the switches to establish electrical connection between the windings 130 and the electrical device 110 based on communication received from the main controller 200.

In some embodiments, aforementioned capabilities of the main controller 200 to establish electrical communication between the windings 130 and the electrical device 110 may be embedded in the motor controller 160, in the device controller 170, or in both the motor controller 160 and the device controller 170.

In some embodiments, the electronic circuit between the windings 130 and the electrical device 110 may be configured such that the windings 130 can be electrically connected with the electrical device 110 in various combinations. The electronic circuit may facilitate arranging the windings 130 in various arrangements like series, parallel, series parallel, start, delta, etc. The switches in the electronic circuit may be operated to arrange the windings 130 in specific arrangement. For example, the control circuitry 120 may operate the switches in the electronic circuit to arrange the windings 130 in specific arrangement based on inductance value in windings 130 and charge required by the energy storage element 150. In some embodiments, the switches for arranging windings 130 are provided as part of the integrated circuit or ASIC.

In some embodiments, the windings 130 are center tapped in the electronic circuit to provide a precise inductance value. In center tapping, electrical contact may be established with a substantial middle point along each winding 130.

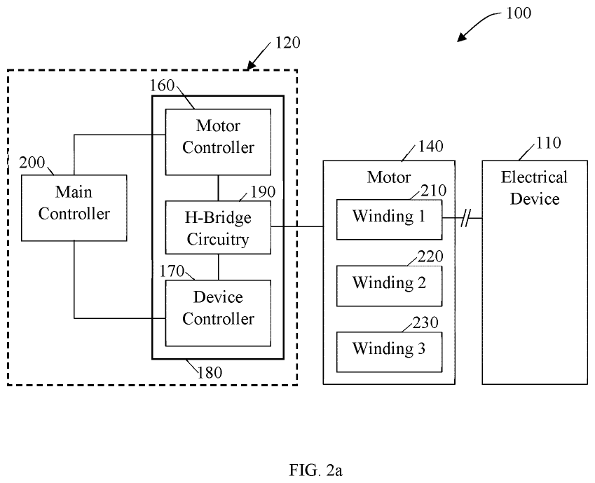

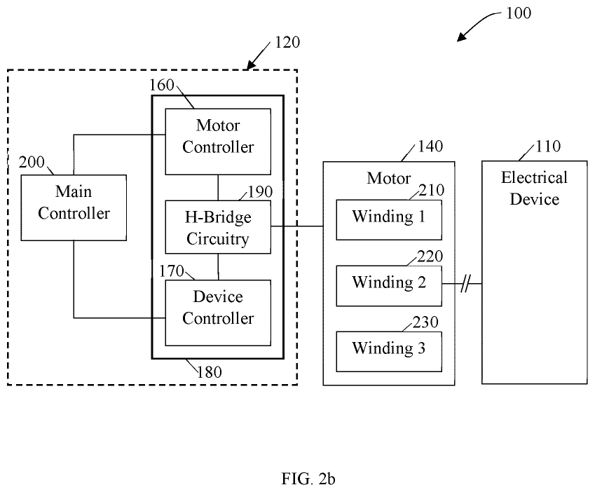

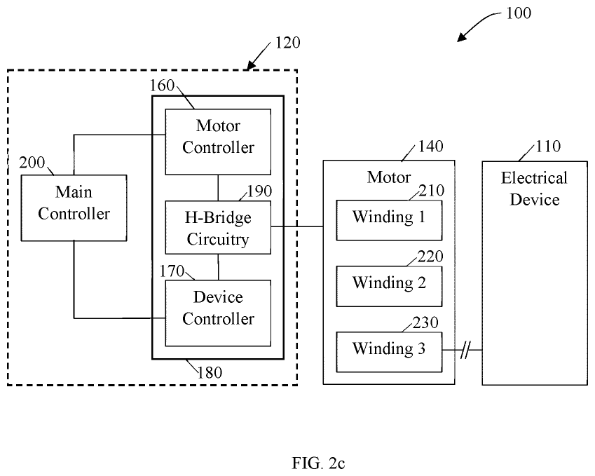

Referring to FIGS. 2a-2c, the system 100 is shown according to another aspect of the present disclosure. In FIGS. 1-2c, common parts have been given like reference numerals, and a description thereof has been omitted unless there is a particular need. It is understood that description of common parts described in foregoing paragraphs applies to parts of FIGS. 2a-2c unless it is specifically described.

In certain operating scenarios, for example, in multi-phase motors, the motor may have certain windings that provide motion to the rotor of the motor and certain other windings may remain idle (not provide motion to the rotor) when the motor is commutating. In such cases, the control circuitry may establish electrical connection between one or more idle windings and the electrical device, when the motor is still commutating. The main controller may coordinate with the motor controller in a time-slicing fashion for precise control and to avoid shoot-through. In some embodiments, the time-slicing methodology may be similar to that of SIMO implementations, whereby the function of the winding is shared between the motor controller for motion control and as a power supply inductor rather than for dual voltage outputs.

Referring to FIG. 2a, the motor 140 is shown to include a first winding 210, a second winding 220, and a third winding 230. In one operating configuration of the motor 140, the second winding 220 and the third winding 230 may provide motion to the rotor of the motor 140, whereas the first winding 210 may be idle. In such case, the control circuitry 120 may establish electrical connection between idle first winding 210 and the electrical device 110. In some embodiments, the main controller 200 may receive operational status of the windings 210-230 from the motor controller 160, and further configured to establish electrical connection between one or more idle windings of the motor 140 and the electrical device 110. The control circuitry 120 may utilize the H-bridge circuitry 190 to establish electrical connection between the idle winding(s) and the electrical device 110, and may continue to operate to operate the motor 140 by utilizing remaining windings.

Referring to FIG. 2b, the first winding 210 and the third winding 230 may be operational, and the second winding 220 may be idle. In such case, the control circuitry 120 may establish electrical connection between idle second winding 220 and the electrical device 110.

Referring to FIG. 2c, the first winding 210 and the second winding 220 may be operational, and the third winding 230 may be idle. In such case, the control circuitry 120 may establish electrical connection between idle third winding 230 and the electrical device 110.

It is to be noted that the motor 140 is not limited to three windings, and the motor 140 can have any suitable number of windings in other embodiments. The control circuitry 120 may establish electrical connection between one or more idle windings and the electrical device 110, when the motor 140 is commutating. The number of idle windings to be connected to the electrical device 110 may be determined based on inductance value of the idle windings and requirement of the electrical device 110.

In accordance with yet another aspect of the present disclosure, the system may include two or more electrical devices, wherein the control circuitry may selectively engage one or more idle windings of the motor with one or more electrical devices. In some embodiments, the control circuitry may receive required inductance value from the electrical devices, and determine number of windings to be electrically connected with each electrical device. The control circuitry may include a device controller that controls all electrical devices.

In some other embodiments, the control circuitry may include multiple device controllers, wherein each device controller may be associated with one or more electrical devices. Based on inductance available in idle windings, the control circuitry may connect a single winding with each electrical device separately or may connect more than one winding with the electrical device. In some other embodiments, one or more windings may be electrically connected with multiple electronic devices based on inductance value in the winding and requirement of the electrical devices.

In accordance with yet another aspect of the present disclosure, the motor can have one or more supplemental windings to allow for ‘vampire’ transformer coupling, wherein some of the energy normally converted to motion is harvested for lower-power downstream applications. Similarly, back-EMF of a pulse-controller motor can be used for energy harvesting during off periods. In some other embodiments, a formal transformer winding is added in the motor to provide isolation, as in the case of a flyback or fly-buck topology. When not commutating, two coupled motor windings can be used to provide the same function as a traditional transformer in an SMPS.

In accordance with one aspect of the present disclosure, the system comprises one or more electrical devices and a control circuitry provided to selectively establish electrical connection between one or more idle windings of the one or more motors and the one or more electrical devices. The idle windings function as an inductor for the electrical devices.

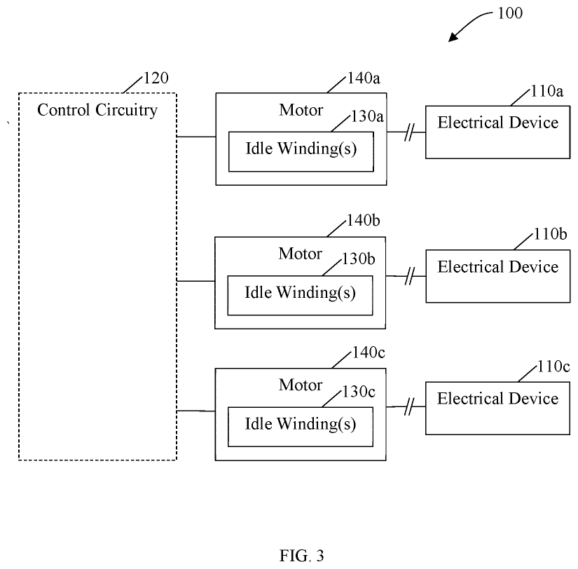

Referring to FIG. 3, two or more motors 140a-140c may be in communication with the control circuitry 120. The control circuitry 120 may include motor controllers for controlling operation of the motors 140a-140c, respectively. In some embodiments, the control circuitry 120 may include a single motor controller that controls all motors or a set of motors. The control circuitry 120 is configured to electrically couple one or more idle windings 130a-130c of the motors 140a-140c to the electrical devices 110a-110c based on inductance value in the idle windings 130a-130c and/or requirement of the electrical devices 110a-110c. It is to be noted that the present disclosure is not limited to number of windings and number of motors shown in FIG. 3, and the system 100 can repurpose any number of windings of multiple motors.

In some other embodiments, the control circuitry 120 may couple the idle windings of two or more motors with single electronic device. In some other embodiments, one or more idle windings of one motor may be coupled with multiple electronic devices. The control circuitry 120 may determine number of idle windings per motor and number of motors to be coupled with one or more electrical devices based on inductance value in the idle windings and/or requirement of the electrical devices.

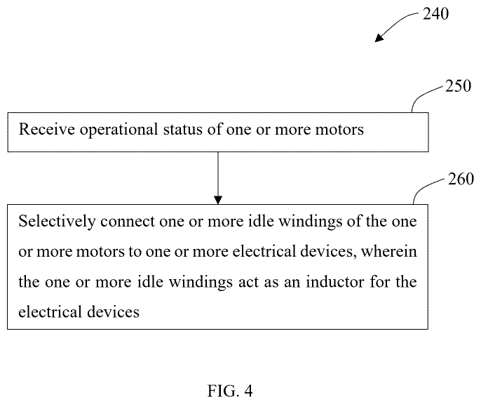

Referring to FIG. 4, a method 240 is shown to include following steps. Steps of the method 240 may be executed using the system 100. The method 240 includes a step of receiving operational status of one or more motors 140a-140c (Step 250). The operational status may include whether the motors 140a-140c are commutating or not, details of idle windings in the motors 140a-140c, etc. The method 240 further includes a step of selectively connecting one or more idle windings of the one or more motors 140a-140c to one or more electrical devices 110a-110c (Step 260). Once connected, the one or more idle windings function as an inductor for the electrical devices 110a-110c to which the idle windings are connected. In case of one or more motors 140a-140c are idle, the control circuitry 120 may connect one or more windings of the idle motors to one or more electrical devices 110a-110c. In case of one or more motors 140a-140c are multi-phase motors, the control circuitry 120 may connect one or more idle windings of the multi-phase motors to one or more electrical devices 110a-110c even when the multi-phase motors are commutating. The control circuitry 120 may determine number of idle windings to be connected to one electrical device based on inductance value of each windings and requirement of the electrical device. In some other embodiments, the control circuitry 120 may connect one or more idle windings to multiple electrical devices.

### Configuration of Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the disclosure describes specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A system to repurpose one or more windings of a motor, the system comprising:
an electrical device; and
a control circuitry provided to selectively establish electrical connection between one or more windings of the motor and the electrical device, wherein the one or more windings function as an inductor for the electrical device.

2. The system of claim 1, wherein the electrical device is a switched-mode power supply unit.

3. The system of claim 1, wherein the one or more windings are center tapped to provide a precise inductance value.

4. The system of claim 1, wherein the control circuitry establishes electrical connection between the one or more windings and the electrical device when the motor is idle.

5. The system of claim 1, wherein the motor is commutating, and the control circuitry establishes electrical connection between the one or more windings and the electrical device, the one or more windings being the one or more idle windings.

6. The system of claim 1, wherein the one or more windings are combined in one of a parallel, series, or series parallel combinations.

7. A system to repurpose one or more windings of one or more motors, the system comprising:
one or more electrical devices; and
a control circuitry provided to selectively establish electrical connection between one or more idle windings of the one or more motors and the one or more electrical devices, wherein the idle windings function as an inductor for the electrical devices.

8. The system of claim 7, wherein the one or more electrical devices is a switched-mode power supply unit.

9. The system of claim 7, wherein the one or more idle windings are center tapped to provide a precise inductance value.

10. The system of claim 7, wherein the control circuitry establishes electrical connection between the one or more idle windings and the one or more electrical devices when a motor is idle.

11. The system of claim 7, wherein the motor is commutating, and the control circuitry establishes electrical connection between the one or more idle windings and the one or more electrical devices.

12. The system of claim 7, wherein the control circuitry is part of an integrated circuit.

13. The system of claim 7, wherein the one or more electrical devices comprises a failsafe return actuator.

14. A method comprising:
receiving operational status of one or more motors; and
selectively connecting one or more idle windings of the one or more motors to one or more electrical devices, wherein the one or more idle windings function as an inductor for the electrical devices.

15. The method of claim 14, wherein the one or more devices comprise a three phase motor.

16. The method of claim 14, wherein the selectively connecting is performed by an application specific integrated circuit.

17. The method of claim 14, further comprising:
returning an actuator to a failsafe position using the one or more idle windings.

18. The method of claim 14, wherein the one or more idle windings are idle motor windings.

19. The method of claim 14, further comprising:
harvesting energy normally converted to motion for lower-power downstream applications using the one or more windings.

20. The method of claim 14, wherein the selectively connecting is performed using H-bridge circuitry.
